(19) United States
(12) Patent Application Publication
(10) Pub. No.: US 2025/0354023 A1
(43) Pub. Date: Nov. 20, 2025

(54) RAISED FOAM SILICONE RESIN COMPOSITION FOR PRINTING, RAISED FOAM SILICONE RESIN FOR PRINTING, AND PRINTING AGENT CONTAINING THE SAME

(71) Applicant: HANYANG PETROCHEMICAL CO.,LTD., Ansan-si (KR)

(72) Inventor: WON BOK KIM, Ansan-si (KR)

(73) Assignee: HANYANG PETROCHEMICAL CO.,LTD., Ansan-si (KR)

(21) Appl. No.: 19/095,538

(22) Filed: Mar. 31, 2025

(30) Foreign Application Priority Data
May 20, 2024 (KR) 10-2024-0065297

(51) Int. Cl. C09D 11/033; C09D 11/037; C09D 11/102

(52) U.S. Cl. CPC C09D 11/033; C09D 11/037; C09D 11/102

(57) ABSTRACT

The present invention relates to a pile-type raised foam silicone resin composition, a pile-type raised foam silicone resin comprising the same, and a printing agent using the same. The present invention also relates to a printing material that can impart a three-dimensional velvet effect, a shimmering effect, an improved soft tactile sensation, and flexibility to a printed product, and a novel printing agent and a printed product using the printing material.

### CROSS-REFERENCE TO RELATED APPLICATIONS

This application claims the benefit of Korean Patent Application No. 10-2024-0065297 filed on May 20, 2024 in the Korean Intellectual Property Office, which is incorporated herein by reference in its entirety.

### BACKGROUND OF THE INVENTION

### 1. Field of the Invention

The present invention relates to a raised foam silicone resin, a printing agent comprising the same, and a printing method and a printed product using the printing agent.

### 2. Description of Related Art

In general, examples of methods of dyeing fabrics include dip dyeing in which a fabric is immersed in a dye solution to dye the fabric, and printing in which a mixture of dye or pigment with a thickener is printed onto the surface of the fabric using a screen or roller.

Dip dyeing refers to a process in which a material to be dyed is dipped in a dye solution to cause the material to be uniformly dyed in the same color, and is often used as a generic term for solid dyeing. A mechanical device is mostly used in dip dyeing. Since such a mechanical device is very simple in structure, the to-be-dyed material is partially immersed in the dye solution while being rotated. Generally, as the mechanical device, a jigger is used for fabrics such as cotton, silk, rayon and the like and a winch is used for woolen fabrics. The jigger is a simple dyeing machine consisting of a pair of rollers and a dyeing bath having a dyeing solution contained therein. An uncut fabric is wound on one roller and then fed to and wound on the other while being immersed in the dye solution. Subsequently, the fabric is dyed while being wound in the reverse direction to the winding direction and this process is repeatedly performed several times until a desired color is created. The winch is a dyeing machine in which a number of bars are securely fixed around the circumferences of a pair of opposed elliptical or circular plates in a traverse direction to rotate the bars to feed the fabric. The circular plates are used in the dip dyeing of woolen fabrics and the elliptical plates are used in the dip dyeing of other kinds of fabrics. In addition, when the fabric is dyed in large amounts, a continuous dyeing machine is used in which a plurality of units for performing dyeing, washing, tendering, and drying are connected in a row.

Printing refers to a process in which patterns are dyed onto an uncut fabric. Printing also refers to a technique which is used for paper or other materials, but in the case of yarn or fabric, particularly fabric, it is partially colored to create required patterns thereon. Printing can be classified in various manners. In other words, printing is classified into synthetic fabric printing, cotton fabric printing, woolen fabric printing, and silk fabric printing depending on the type of fabrics to be printed. It is also classified into machine printing and hand printing depending on whether the printing process is mechanical or manual.

Machine printing is re-classified into roller printing, automatic screen printing, rotary screen printing, transfer printing, and digital textile printing (DTP).

Roller printing is a printing method in which a motif or pattern is engraved on copper or iron rollers to have a concavo-convex shape and then dye is applied to the engraved portions of the rollers and a fabric is allowed to be passed through the motif or pattern-engraved rollers to dye the fabric. Roller printing is the oldest machine printing method that is mainly used for a simple pattern with a small number of colors, a stripe pattern, and a dot pattern.

Automatic screen printing is the recently most used machine printing method in which a screen frame is securely fixed on a printing table that is installed in a horizontal state, and a squeegee is moved across the screen to vertically squeeze and apply dye onto a fabric attached to an endless belt, and then the fabric is automatically moved to conform to the screen frame.

Rotary screen printing refers to a printing method in which a cylindrical metal screen frame used as a substitute for the flat screen frame of the automatic screen printing is in a rotating state and the fabric attached to the belt is moved continuously to allow patterns to be printed on the fabric. In the rotary screen printing process, an improved machine is used in which a roller printing machine and an automatic screen printing machine are combined.

Transfer printing refers to a printing method in which a transfer dye is printed on a paper and then the fabric and the printed paper are pressed with heat of a suitable temperature to allow the transfer dye to be printed on the fabric. In the transfer printing process, the printing technology is applied to printing in order to create a delicate, realistic effect.

Hand printing is re-classified into block printing, stencil printing, spray printing, batik printing, painted dyeing, tie dyeing, gravure printing, and vigoureux printing. Block printing refers to a printing method in which patterns are carved onto wood, rubber, or linoleum plates, and then dye is applied onto the carved plates and the patterns are stamped onto the fabric, similar to stamping. It is the oldest printing method in the history of textile printing.

Stencil printing refers to a printing method in which a desired motif of a stencil is cut out using a knife, scissors, or any other similar tool, and then the cut-out stencil is placed on the fabric, after which dye is scraped over the stencil to pass through the perforated parts of the stencil to create a pattern. It also refers to a printing method in which dye is sprayed onto the stencil.

Spray printing refers to a printing method employing a technique in which a stencil carved with a desired motif is placed on the fabric and a colored dye is sprayed onto the stencil, a technique in which a desired motif is drawn with a dye containing a reducing agent or resist agent, and then another colored dye is sprayed over the motif to create a pattern, and a technique in which various colored dyes are sprayed across the entire fabric using a sprayer.

Batik printing refers to a traditional printing method that has primarily been practiced by the Javanese. In the batik printing method, lead, wax, paraffin, or the like is used to create a background or motif. Thereafter, the fabric is dyed, and then it is crumpled or folded either regularly or irregularly to create a random effect. This printing technique exhibits an excellent cracking effect due to the cracks in the wax.

As discussed above, a base fabric used in textiles or similar materials can be processed into a fabric with a desired color and pattern depending on aforementioned various printing methods. However, these printing methods have the limitation in that since the patters are flat, they are restricted in implementing the aesthetics of the fabric, resulting only in a flat visual effect. In view of this limitation, there is a need for a printing method for obtaining a fabric that expresses more diverse and three-dimensional patterns.

As a conventional method for imparting a three-dimensional effect, techniques in the related art are proposed which typically comprise adding stone granules to a fabric to create a three-dimensional pattern, or printing a fabric that has a three-dimensional texture created thereon.”

However, the conventional printing method of imparting such a three-dimensional effect entails a problem in that it is limited in its application to inkjet printing, transfer printing, or digital textile printing that is widely used in There is therefore an increasing need for a recent days. printing material enabling the creation of a three-dimensional effect different from existing ones.

### PRIOR ART LITERATURE

### Patent Documents

Patent document 1: Korean Patent Laid-Open Publication No. 10-2005-0016796 (laid-open on 21.02.2005)

Patent document 2: Korean Patent Laid-Open Publication No. 10-2009-0133031 (laid-open on 31.12.2009)

### SUMMARY OF THE INVENTION

Accordingly, the present invention has been made to solve the aforementioned problems occurring in the prior art, and it is an object of the present invention to provide a printing material that can impart a three-dimensional velvet effect, a shimmering effect, and an improved soft tactile sensation to a printed product through the application of a pile-type, raised foam silicone resin with a specific composition, which can address the drawback of conventional silicone-based printing materials that provide only a flat visual effect, lack or have insufficient flexibility, and result in a hard tactile sensation. Additionally, the object of the invention is to provide a printed product subjected to printing treatment using the printing material.

To achieve the above object, the present invention provides a raised foam silicone resin composition for printing, which comprises a silicone resin, a foaming agent, and a carbomer.

In addition, the present invention provides a printing agent comprising a mixture of the raised foam silicone resin composition.

Further, the present invention provides a printed product subjected to printing treatment using the printing agent.

Further, the present invention provides a printing method using the printing agent.

### EFFECTS OF THE INVENTION

The raised foam silicone resin for printing according to the present invention has the characteristics that when the raised foam silicone resin is heat-treated at a specific temperature, it is foamed and raised in the form of soap bubbles. Thus, the raised foam silicone resin applied as the printing material can impart a velvet effect and a shimmering effect (or a hiding power) by reflection of light to the printing agent

Further, the printing agent can increase the printing height of the printed product by more than twice, thereby reducing the number of printing operations and significantly lowering the production cost of the printed product. Additionally, due to the excellent color development of the colorant in the printing agent, it is possible to achieve color expression even with a small amount of pigment. Furthermore, the printed areas exhibit a soft tactile sensation while also possessing excellent flexibility.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be apparent from the following detailed description of the preferred embodiments of the invention when taken in conjunction with the accompanying drawings, in which:

FIG. 1A is a conceptual view showing the foaming and raising state of the raised foam silicone resin for printing according to the present invention, before and after heat treatment, and FIG. 1B shows cross-sectional photographs confirming the foaming and raising state of the raised foam silicone resin produced in Example 1, before and after heat treatment;

FIG. 2 is a photograph of the surface of a printed product subjected to printing treatment as obtained in Preparation Example 1

FIG. 3 is a photograph of the surface of a printed product subjected to printing treatment as obtained in Preparation Example 2; and

FIG. 4 is a photograph of the surface of a printed product subjected to printing treatment as obtained in Preparation Example 3.

### DETAILED DESCRIPTION OF THE PREFERRED EMBODIMENTS

Hereinafter, the present invention will be described in more detail with reference to the accompanying drawings by way of Examples. However, it will be obvious to those skilled in the art that the scope of the present invention is not limited by only these Examples.

As used herein, the term “velvet effect” means having a texture that is visually and tactilely similar to that of suede or chamois.

A raised foam silicone resin composition for printing according to the present invention comprises a silicone resin (i.e., main resin) as a pile-type raised foam resin, a foaming agent, and a carbomer. The raised foam silicone resin composition preferably comprises 9.7 to 20.0 wt % of a foaming agent, 0.3 to 1.0 wt % of a carbomer, and the balance of a silicone resin, and more preferably comprises 12.0 to 17.0 wt % of a foaming agent, 0.4 to 0.9 wt % of a carbomer, and the balance of a silicone resin.

The foaming agent of the silicone resin composition for printing comprises a C₁-C₄ alcohol), preferably a C₁-C₃ alcohol, more preferably ethanol and/or propanol. Further, almost 100% alcohol containing no water is used as the alcohol in the foaming agent. This is because if the alcohol contains water (moisture), it may adversely affect the ability of the resin to be foamed and raised.

If the content of the foaming agent in the silicone resin composition for printing is less than 9.7 wt %, the suede texture effect may be insufficient. On the contrary, if the content of the foaming agent in the silicone resin composition for printing exceeds 20.0 wt %, a printed product may be easily broken due to the excessive foaming ability of the resin, and the miscibility and dispersibility of the components in the resin may be significantly reduced due to the greatly increased viscosity of the resin. Therefore, it is preferable to use the foaming agent within the above specified range.

The carbomer in the silicone resin composition for printing serves to adjust the viscosity of the resin. If the content of the carbomer in the silicone resin composition for printing is less than 0.3 wt %, the viscosity adjustment effect may be not exhibited or insufficient due to the too low content. Contrarily, if the content of the carbomer exceeds 1.0 wt %, the miscibility of other components in the printing agent may be reduced. Therefore, it is preferable to use the carbomer within the above specified range.

In addition, the silicone resin as the main resin in the silicone resin composition for printing comprises a vinyl-terminated polydi (C₁-C₃ alkyl) siloxane and a silicon dioxide. The silicone resin may preferably comprise a vinyl-terminated polydi (C₁-C₂ alkyl) siloxane and a silicon dioxide, more preferably comprise a vinyl-terminated polydimethylsiloxane and a silicon dioxide.

The silicon dioxide in the silicone resin that is used in the present invention may have an average particle diameter of 200 nm to 3,000 nm, preferably 400 nm to 2,000 nm. If the average particle diameter of the silicon dioxide used in the present invention is less than 200 nm, there may occur a problem in that the silicone resin for printing or the printing agent containing the silicone resin is entirely foamed during heat treatment, resulting in the failure to form a regularly foamed and raised pattern, which it is desired to produce. On the contrary, if the average particle diameter of the silicon dioxide exceeds 3,000 nm, the raised pattern may be formed too randomly. Therefore, it is preferable to use the silicon dioxide having the average particle diameter within the above specified range.

Further, the content of the silicon dioxide in the silicone resin is 19 to 26 wt %, preferably 21.0 to 25.0 wt %, more preferably 21.5 to 24.5 wt %. If the content of the silicon dioxide in the silicone resin is less than 19 wt % or exceeds 26 wt %, the raised pattern may not be formed uniformly, and thus the hiding power and the velvet effect of the printed product subjected to printing treatment may be insufficient. Therefore, it is preferable to use the content of the silicon dioxide within the above specified range.

In addition, the content of the vinyl-terminated polydi (C₁-C₃ alkyl) siloxane in the silicone resin is the balance thereof up to 100 wt % except for the silicon dioxide.

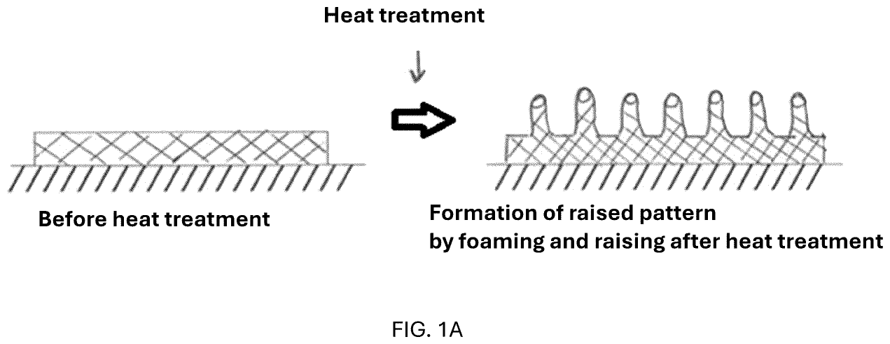

A pile-type raised foam silicone resin as a mixture of the raised foam silicone resin composition having the above composition is heat-treated at 130 to 180° C., preferably 140 to 180° C., more preferably 145 to 178° C. for 5 seconds or less, preferably 2 to 5 seconds to cause the pile-type raised foam silicone resin to be foamed and raised, thereby creating a raised pattern in the form of soap bubbles or the like (see FIGS. 1a and 1b). The content, and the heat treatment temperature and time of the component in the composition may be adjusted to control the degree of foaming and raising.

Further, the pile-type raised foam silicone resin of the present invention may be foamed with a volume expansion ratio of 30 to 120 times, preferably 60 to 120 times, more preferably 80 to 115 times.

The pile-type raised foam silicone resin as described above is introduced as a printing material to impart the velvet effect to the printing agent, and light is reflected by the printed pattern formed on the printed areas to allow the printing agent to exhibit the shimmering effect. Further, the pile-type raised foam silicone resin can impart the three-dimensional aesthetics and increase the printing height of the printed product by more than twice, thereby reducing the number operations the of printing and significantly lowering production cost of the printed product. Additionally, due to the excellent color development of the pigment in the printing agent, it is possible to achieve color expression even with a small amount of pigment.

In a preferred embodiment of the printing agent, the printing agent of the present invention may comprise the pile-type raised foam silicone resin, a colorant, and an additive.

In a preferred embodiment of the present invention, the printing agent, may comprise the pile-type raised foam silicone resin, a colorant, and an additive.

The colorant may comprise at least one selected from a pigment and a dye.

The pigment may comprise at least one selected from a neutral pigment and an oil-based pigment. Preferably, the neutral pigment is used from an eco-friendly perspective.

As the neutral pigment and/or the oil-based pigment, a commonly available pigment in the relevant art may be used.

In addition, the additive used in the present invention may comprise titanium dioxide, a filler, a diluent, a curing agent, a dispersing agent, and/or a leveling agent, along with other general additives used in the relevant art, depending on the type of a to-be-dyed material that needs to be manufactured.

Moreover, the adjustment of the content of the pile-type raised foam silicone resin in the printing agent enables the control of the three-dimensional aesthetics, suede texture, and hiding power of the printed product.

Further, various printing processes such as screen printing, roller printing, transfer printing, or digital textile printing may be performed on the printed product using the printing agent.

### EXAMPLES

Hereinafter, the present invention will be described in further detail with reference to examples. It will be obvious to a person having ordinary skill in the art that these examples are for illustrative purpose only and are not to be construed to limit the scope of the present invention.

### Example 1: Production of Pile-Type Raised Foam Silicone Resin

23.0 wt % of a silicon dioxide having an average particle diameter of about 1,200 nm was mixed with 77.0 wt % of a vinyl-terminated polydimethylsiloxane to thereby obtain a silicone resin.

15.3 wt % of ethanol with a concentration of about 100% as a foaming agent, 0.62 wt % of a carbomer, and the balance of the silicone resin up to 100 wt % are mixed together to thereby obtain a pile-type raised foam silicone resin.

### Examples 2 to 5 and Comparative Examples 1 to 4

Each pile-type raised foam silicone resin having the composition as shown in Table 1 below was produced in the same manner as in Example 1, and Examples 2 to 4 and Comparative

### Examples 1 to 5 were performed accordingly. Example 6

A pile-type raised foam silicone resin was produced in the same manner as in Example 1. In this case, propanol with a concentration of about 100 was used as the foaming agent instead of ethanol.

TABLE 1

| | | | | Silicone resin | |
|---|---|---|---|---|---|
| | | | | composition | |
| | | | | | Vinyl- |
| Classifi- | Foaming | | | | terminated |
| cation | agent | | Silicone | Silicon | polydimethyl- |
| (wt %) | Ethanol | Carbomer | resin | dioxide | siloxane |
| Example 1 | 15.3 | 0.62 | balance | 23.0 | 77.0 |
| Example 2 | 15.3 | 0.36 | | 23.0 | 77.0 |
| Example 3 | 15.3 | 0.95 | | 23.0 | 77.0 |
| Example 4 | 12.2 | 0.62 | | 23.0 | 77.0 |
| Example 5 | 17.9 | 0.62 | | 23.0 | 77.0 |
| Example 6 | 15.3 | 0.62 | | 23.0 | 77.0 |
| Comparative | 15.3 | 0.62 | | 0 | 100 |
| Example 1 | | | | | |
| Comparative | 15.3 | 0 | | 23.0 | 77.0 |
| Example 2 | | | | | |
| Comparative | 15.3 | 1.22 | | 23.0 | 77.0 |
| Example 3 | | | | | |
| Comparative | 9.2 | 0.62 | | 23.0 | 77.0 |
| Example 4 | | | | | |
| Comparative | 20.8 | 0.62 | | 23.0 | 77.0 |
| Example 5 | | | | | |

### Experimental Example 1: Measurement of Volume Change and Raised Pattern Height

The pile-type raised foam silicone resin produced in Examples and Comparative Examples was coated to a thickness of about 0.4 mm on a fabric, and then heat-treated at 170 to 172° C. for 4 seconds. Thereafter, the volume change of the silicone resin before and after the heat treatment was measured and the results of the measurement are shown in Table 2 below.

The pile-type raised foam silicone resin obtained in Example 1 was used in Examples 7 to 8 and Comparative Examples 6 to 8 shown in Table 2 below. The average height and the volume change of the raised pattern formed by foaming and raising the silicone resin were measured under different heat treatment conditions. In this case, the volume change was calculated based on the average height of the raised pattern before and after heat treatment.

In addition, the cross-sectional photograph of the raised pattern formed by foaming and raising the pile-type raised foam silicone resin of Example 1 is shown in FIG. 1b. The cross-sectional photograph shown in FIG. 1b

The cross-sectional image in FIG. 1b was taken using a video microscope with a magnification of 140 times, after being commissioned to the KOTTI Testing and Research Institute.

Further, the surface state of the raised pattern was evaluated through comprehensive tactile and visual observation, including suede texture and coating smoothness (○: Excellent, Δ: Moderate, X: Poor).

TABLE 2

| | | Height of | | | | |
|---|---|---|---|---|---|---|
| | | raised | | | | |
| | Heat treatment | pattern | | | | |
| | conditions Temp./ | (average | | Volume | | Surface |
| Classification | Time | height) | | change | | states |
| Example 1 | 170 to 172° C./4 sec | 1.2 | mm | 113 | times | ◯ |
| Example 2 | 170 to 172° C./4 sec | 1.1 | mm | 98 | times | ◯ |
| Example 3 | 170 to 172° C./4 sec | 1.0 | mm | 92 | times | ◯ |
| Example 4 | 170 to 172° C./4 sec | 0.8 | mm | 46 | times | ◯ |
| Example 5 | 170 to 172° C./4 sec | 1.3 | mm | 135 | times | ◯ |
| Example 6 | 170 to 172° C./4 sec | 1.0 | mm | 94 | times | ◯ |
| Example 7 | 140 to 142° C./4 sec | 0.8 | mm | 33 | times | Δ |
| Example 8 | 150 to 152° C./4 sec | 1.0 | mm | 65 | times | ◯ |
| Comparative | 170 to 172° C./4 sec | 0.7 | mm | 27 | times | X |
| Example 1 | | | | | | |
| Comparative | 170 to 172° C./4 sec | 0.4 | mm | 17 | times | X |
| Example 2 | | | | | | |
| Comparative | 170 to 172° C./4 sec | 0.8 | mm | 52 | times | Δ |
| Example 3 | | | | | | |
| Comparative | 170 to 172° C./4 sec | 0.6 | mm | 26 | times | X |
| Example 4 | | | | | | |
| Comparative | 170 to 172° C./4 sec | 1.3 | mm | 96 | times | Δ |
| Example 5 | | | | | | |
| Comparative | 125 to 127° C./4 sec | 0.2 | mm | 5 | times | X |
| Example 6 | | | | | | |
| Comparative | 190 to 192° C./4 sec | 1.3 | mm | 143 | times | Δ |
| Example 7 | | | | | | |
| Comparative | 170 to 172° C./6 sec | 1.2 | mm | 112 | times | ◯ |

Example 8

Referring to Table 2, the printed products obtained in Examples 1 to 8 generally showed a high formation of raised patterns, a high volume change, and an excellent surface state.

As the foaming agent, the use of ethanol showed a relatively advantageous tendency in terms of raised pattern height and volume change compared to Example 6, where propanol was used.

In addition, in the case of Comparative Example 1, where a silicone resin containing no silicon dioxide was used, it was found that the foaming ability was reduced, the raised pattern was not formed uniformly, and the surface state of the raised pattern was somewhat poor.

Further, in the case of Comparative Example 2, where carbomer was not used, it was found that the resin was absorbed in large amounts into the fabric. As a result, a low-height raised pattern was formed and the volume change of the raised pattern was low, resulting in a significant decrease in suede texture.

In addition, in the case of Comparative Example 3, where the carbomer was used in an amount of 1.2 wt %, which exceeds 1.0 wt %, it was found that the foaming effect was decreased compared to Example 3.

In addition, in the case of Comparative Example 4, where the foaming agent was used in an amount of 9.2 wt % only, which is less than 9.7 wt %, it was found that the height and the volume change of the raised pattern were significantly lower compared to Example 4 (12.2 wt %), resulting in diminished suede texture effect.

Furthermore, in the case of Comparative Example 5, where the foaming agent was used in an amount of 20.8 wt % only, exceeding 20.0 wt %, it was found that the volume change of the raised pattern was rather lower, and the surface state of the raised pattern is poor compared to Example 5 (17.9 wt %) because the raised pattern broke due to excessive expansion and the raised pattern was not formed uniformly. As a result, it was confirmed that the surface of the printed product felt somewhat hard, and the smooth texture was significantly reduced.

Besides, in the case of Comparative Example 6, where the heat treatment was performed on the raised foam silicone resin at 125 to 127° C., it was found that the formation rate and the height of the raised pattern were low, resulting in a poor state of the surface.

In addition, in the case of Comparative Example 7, where the heat treatment was performed on the raised foam silicone resin at 190 to 192° C., it was found that the foamability was good, but there were problems with the fabric corresponding to the base material burning, and the raised pattern was not formed uniformly, leading to an uneven texture.

Furthermore, in the case of Comparative Example 8, where the heat treatment was performed on the raised foam silicone resin for 6 seconds, exceeding 5 seconds, the result showed no significant difference compared to Example 1.

### Preparation Example 1: Printing Agent and Production of Printed Product Subjected to Printing Treatment 0.5 part by weight of Green 1700 (Manufacturer: Hanyang

Petrochemical Co., Ltd), a neutral pigment, and 3.0 parts by weight of a curing agent, based on 100 parts by weight of the pile-type raised foam silicone resin produced in Example 1, were mixed together to thereby prepare a printing agent.

Subsequently, a cotton fabric was subjected to the printing treatment using the printing agent through the screen- printing method, and then heat-treated at 170° C. for 4 seconds, followed by cooling to thereby produce a printed product with a thickness of about 0.4 mm.

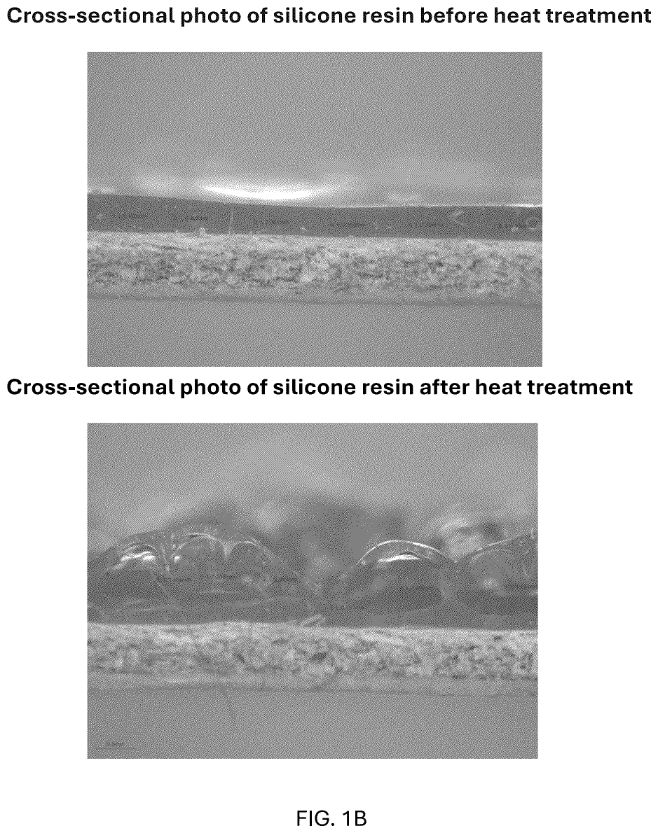

The image of the printed product subjected to printing treatment was shown in FIG. 2.

### Preparation Example 2: Printing Agent and Production of Printed Product Subjected to Printing Treatment

0.5 part by weight of Red 1700 (Manufacturer: Hanyang Petrochemical Co., Ltd), a neutral pigment, and 3.0 parts by weight of a curing agent, based on 100 parts by weight of the pile-type raised foam silicone resin produced in Example 1, were mixed together to thereby prepare a printing agent.

Subsequently, a cotton fabric was subjected to the printing treatment using the printing agent through the screen-printing method, and then heat-treated at 170° C. for 4 seconds, followed by cooling to thereby produce a printed product with a thickness of about 0.4 mm.

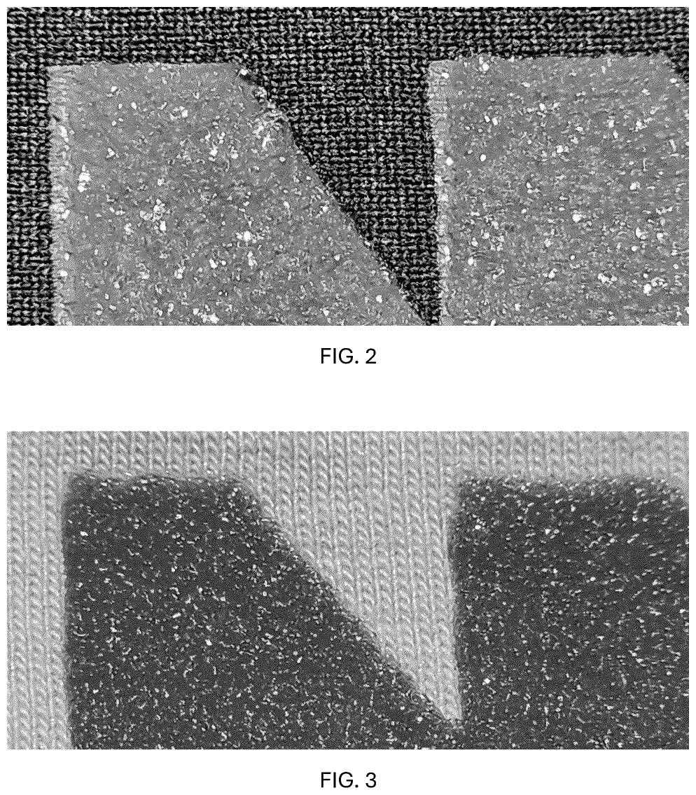

The image of the printed product subjected to printing treatment was shown in FIG. 3.

### Preparation Example 3: Printing Agent and Production of Printed Product Subjected to Printing Treatment

0.5 part by weight of skyblue 1604 (Manufacturer: Hanyang Petrochemical Co., Ltd), a neutral pigment, and 3.0 parts by weight of a curing agent, based on 100 parts by weight of the pile-type raised foam silicone resin produced in Example 1, were mixed together to thereby prepare a printing agent.

Subsequently, a cotton fabric was subjected to the printing treatment using the printing agent through the screen-printing method, and then heat-treated at 170° C. for 4 seconds, followed by cooling to thereby produce a printed product with a thickness of about 0.4 mm.

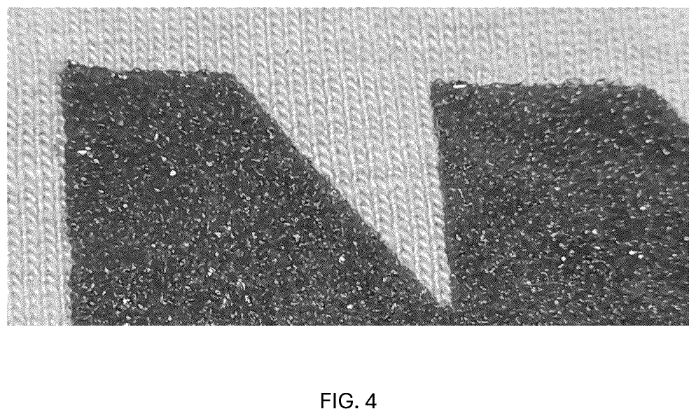

The image of the printed product subjected to printing treatment was shown in FIG. 4.

While the present invention has been described in connection with the exemplary embodiments illustrated in the drawings, they are merely illustrative and the invention is not limited to these embodiments but can be embodied in different various forms. It will be appreciated by a person having an ordinary skill in the art that various equivalent modifications and variations of the embodiments can be made without departing from the spirit and scope of the present invention. Therefore, the true technical scope of the present invention should be defined by the technical sprit of the appended claims.

What is claimed is:

1. A raised foam silicone resin composition for printing, which comprises a silicone resin, a foaming agent, and a carbomer,
wherein the foaming agent comprises a C₁-C₄ alcohol.

2. The raised foam silicone resin composition for printing according to claim 1, which comprises 9.7 to 20.0 wt % of a foaming agent, 0.3 to 1.0 wt % of a carbomer, and the balance of a silicone resin.

3. The raised foam silicone resin composition for printing according to claim 1, wherein the silicone resin comprises a vinyl-terminated polydi (C₁-C₃ alkyl) siloxane and a silicon dioxide.

4. The raised foam silicone resin composition for printing according to claim 3, wherein the silicone resin comprises 19 to 26 wt % of the silicon dioxide and the balance of the vinyl-terminated polydi (C₁-C₃ alkyl) siloxane.

5. The raised foam silicone resin composition for printing according to claim 1, wherein the C₁-C₄ alcohol is an alcohol containing no water, and comprises at least one selected from ethanol and propanol.

6. A raised foam silicone resin for printing, which comprises a mixture of the raised foam silicone resin composition according to claim 1,
wherein when the mixture is heat-treated at 130 to 180° C., it is foamed and raised to thereby create a raised pattern.

7. The raised foam silicone resin for printing according to claim 6, wherein the mixture is foamed with a volume expansion ratio of 80 to 115 times.

8. A printing agent comprising the raised foam silicone resin according to claim 6.

9. The printing agent according to claim 8, which comprises the pile-type raised foam silicone resin, a colorant, and an additive,
wherein the colorant comprises at least one selected from a pigment and a dye, and
wherein the additive comprises at least one selected from among titanium dioxide, a filler, a diluent, a curing agent, a dispersing agent, and a leveling agent.

10. A printed product which is subjected to screen printing, roller printing, transfer printing, or digital textile printing using the printing agent according to claim 8.

11. A printed method comprising the steps of:
subjecting a material to be dyed to printing treatment using the printing agent according to claim 9; and
heat-treating the to-be-dyed material for 5 seconds or less at a temperature of 130 to 180° C.
